(19) United States
(12) Patent Application Publication
(10) Pub. No.: US 2015/0049069 A1
(43) Pub. Date: Feb. 19, 2015

(54) AUTOMATIC BACKUP OF CONFIGURATION-RELATED SETTINGS IN A DATA PROCESSING DEVICE

(71) Applicant: NVIDIA Corporation, Santa Clara, CA (US)

(72) Inventor: Surendhran Sivalingam, Coimbatore (IN)

(73) Assignee: NVIDIA Corporation, Santa Clara, CA (US)

(21) Appl. No.: 13/965,241

(22) Filed: Aug. 13, 2013

(51) Int. Cl. G09G 5/00

(52) U.S. Cl. CPC G09G 5/00
USPC 345/211

(57) ABSTRACT

A method includes executing an instance of a process on a data processing device, and controlling configuration of a display unit, a processor, a memory and/or a power supply of the data processing device through a user interface provided by the process and/or an operating system executing on the data processing device based on continued execution of the instance of the process. The method also includes providing a capability to automatically backup, through the processor in conjunction with a driver component associated with the display unit, the processor and/or the power supply, settings related to one or more specific parameter(s) of the display unit, a screen of the display unit, the processor, the memory, an algorithm executing on the processor and/or the power supply of the data processing device through the user interface as a non-system file to the memory and/or a storage device external to the data processing device.

### FIELD OF TECHNOLOGY

This disclosure relates generally to data processing devices and, more particularly, to a method, a device and/or a system of automatic backup of configuration-related settings in a data processing device.

### BACKGROUND

A user of a data processing device (e.g., a desktop computer, a laptop computer, a notebook computer, a netbook, a mobile device such as a mobile phone or a tablet) may control configuration associated with a display unit, a processor, a memory and/or a power supply thereof through a control panel application provided by an operating system executing on the data processing device. The user may find that a specific set of parameters provide for optimal processing/computing through the data processing device. The user may then desire to share the specific set of parameters with another user possessing a similar data processing device and/or a data processing device associated with a similar computing environment. However, when the operating system provides updates to the control panel application, the specific set of parameters may be overwritten and/or lost.

### SUMMARY

Disclosed are a method, a device and/or a system of automatic backup of configuration-related settings in a data processing device.

In one aspect, a method includes executing an instance of a process on a data processing device, and controlling configuration of a display unit, a processor, a memory and/or a power supply of the data processing device through a user interface provided by the process and/or an operating system executing on the data processing device based on continued execution of the instance of the process. The method also includes providing a capability to automatically backup, through the processor in conjunction with a driver component associated with the display unit, the processor and/or the power supply, settings related to one or more specific parameter(s) of the display unit, a screen of the display unit, the processor, the memory, an algorithm executing on the processor and/or the power supply of the data processing device through the user interface as a non-system file to the memory and/or a storage device external to the data processing device.

In another aspect, a non-transitory medium, readable through a data processing device and including instructions embodied therein that are executable through the data processing device, is disclosed. The non-transitory medium includes instructions to execute an instance of a process on the data processing device, and instructions to control configuration of a display unit, a processor, a memory and/or a power supply of the data processing device through a user interface provided by the process and/or an operating system executing on the data processing device based on continued execution of the instance of the process. The non-transitory medium also includes instructions to provide a capability to automatically backup, through the processor in conjunction with a driver component associated with the display unit, the processor and/or the power supply, settings related to one or more specific parameter(s) of the display unit, a screen of the display unit, the processor, the memory, an algorithm executing on the processor and/or the power supply of the data processing device through the user interface as a non-system file to the memory and/or a storage device external to the data processing device.

In yet another aspect, a data processing device executing an instance of a process is disclosed. The data processing device includes a memory, a processor communicatively coupled to the memory, a display unit and a power supply. The process and/or an operating system executing on the data processing device is configured to provide a user interface to control configuration of the display unit, the processor, the memory and/or the power supply therethrough based on continued execution of the instance of the process. The user interface is further configured to provide a capability to automatically backup, through the processor in conjunction with a driver component associated with the display unit, the processor and/or the power supply, settings related to one or more specific parameter(s) of the display unit, a screen of the display unit, the processor, the memory, an algorithm executing on the processor and/or the power supply as a non-system file to the memory and/or a storage device external to the data processing device.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is an illustrative view of a user interface provided by an application executing on the data processing device of FIG. 1.

FIG. 3 is an illustrative view of backup of configuration-related settings being enabled through the user interface of FIG. 2, according to one or more embodiments.

FIG. 4 is an illustrative view of data flow between elements of the data processing device of FIG. 1 during the backup of the configuration-related settings, according to one or more embodiments.

FIG. 5 is a schematic view of the data processing device of FIG. 1 being coupled to another data processing device.

FIG. 6 is an illustrative view of previewing the configuration-related settings related to a display unit of the data processing device of FIG. 1 prior to application thereof through the user interface of FIGS. 2-3.

FIG. 7 is a process flow diagram detailing the operations involved in automatic backup of configuration-related settings in the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of automatic backup of configuration-related settings in a data processing device. Although the present embodiments have been described with reference to specific example embodiments, it will be evident that various modifications and changes may be made to these embodiments without departing from the broader spirit and scope of the various embodiments.

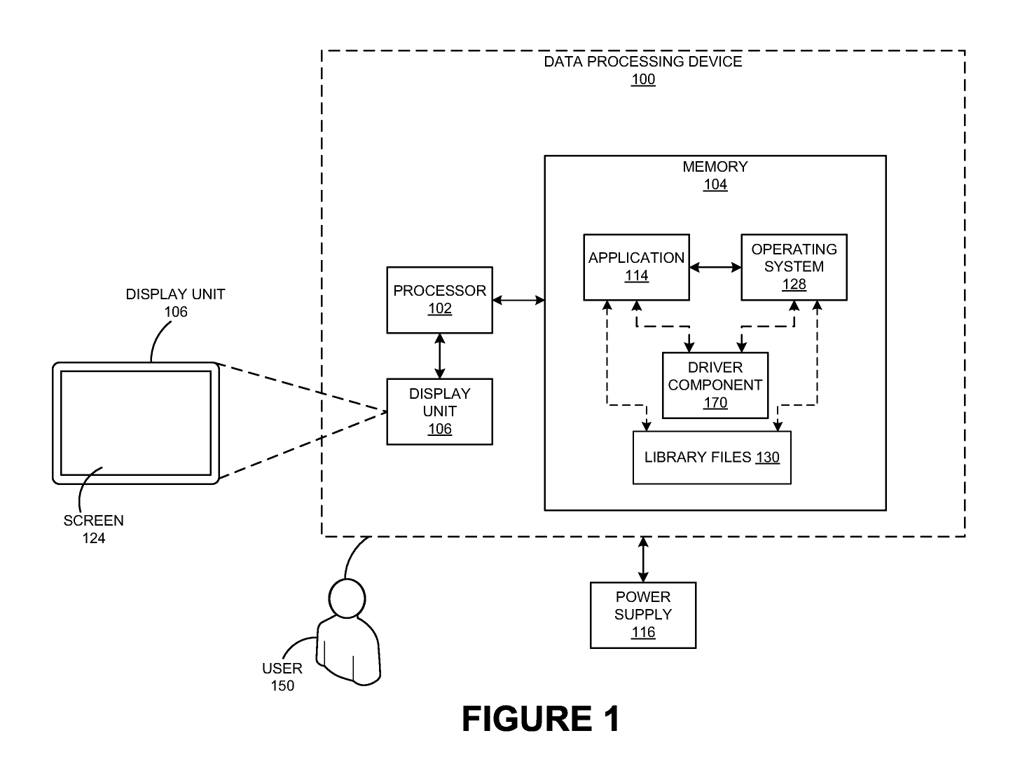

FIG. 1 shows a data processing device 100, according to one or more embodiments. In one or more embodiment, data processing device 100 may be a desktop computer, a laptop computer, a notebook computer, a netbook or a mobile device such as a mobile phone or a tablet. Other forms of the data processing device 100 are within the scope of the exemplary embodiments discussed herein. In one or more embodiments, data processing device 100 may include a processor 102 (e.g., a Central Processing Unit (CPU) and/or a Graphics Processing Unit (GPU)) communicatively coupled to a memory 104 (e.g., a volatile memory and/or a non-volatile memory); memory 104 may include storage locations addressable through processor 102.

In one or more embodiments, data processing device 100 may include a display unit 106 (e.g., a Cathode Ray Tube (CRT) display, a Liquid Crystal Display (LCD)) configured to have display data output from processor 102 rendered thereon. In one or more embodiments, data processing device 100 may execute an instance of a process (e.g., application 114 shown as being stored in memory 104) thereon to enable configuration of a screen 124 of display unit 106 and/or display unit 106. An example application 114 may be NVIDIA® Control Panel configured to control GPUs and Mobile Communication Processors (MCPs). In one or more embodiments, data processing device 100 may be configured to derive power from a power supply 116 (e.g., a battery). FIG. 1 also shows power supply 116 of data processing device 100; although power supply 116 is shown as being external to data processing device 100, it should be noted that power supply 116 may be considered as part of data processing device 100.

In one or more embodiments, data processing device 100 may execute an operating system 128 thereon; FIG. 1 shows operating system 128 as being stored in memory 104. In one or more embodiments, memory 104 may include library files 130 stored therein in order to convenience compatibility of data processing device 100 with a number of operating system environments. In one or more embodiments, application 114 may provide an interface to a user 150 of data processing device 100 to control settings with respect to screen 124, display unit 106, processor 102, memory 104 and/or power supply 116. In one or more embodiments, said settings and/or hardware configurations may be defined in a driver component 170 (e.g., stored in memory 104) associated with display unit 106, processor 102 and/or power supply 116.

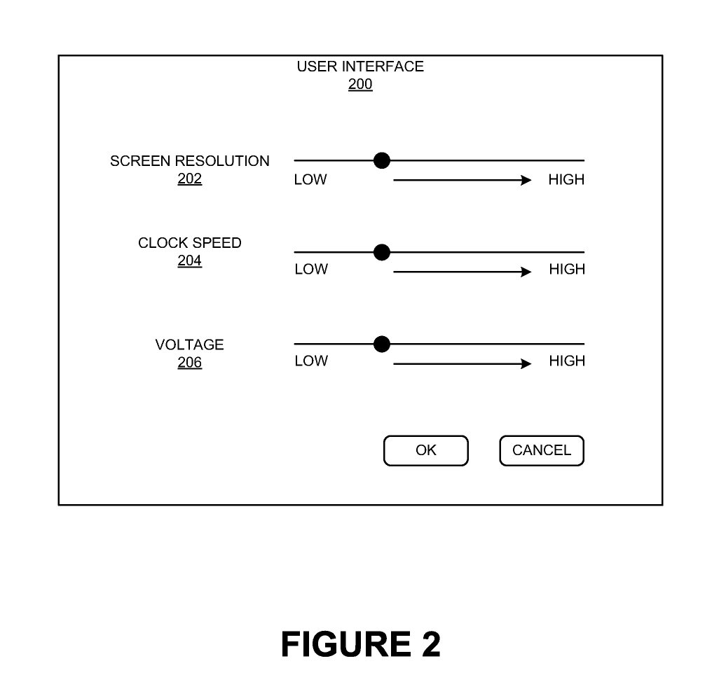

FIG. 2 shows an example user interface 200 provided through application 114. It should be noted that said user interface 200 may be provided also through operating system 128. User 150 may be able to modify settings associated with screen 124, display unit 106, processor 102, memory 104 and/or power supply 116 through user interface 200. Other modifications are within the scope of the exemplary embodiments discussed herein. FIG. 2 shows example parameters capable of being modified by user 150; the example parameters may include screen resolution 202, clock speed 204 and voltage 206. Other parameters are within the scope of the exemplary embodiments discussed herein. For example, processor 102 may execute a noise reduction algorithm on the display data to be rendered on display unit 106; user interface 200 may provide a capability to modify a complexity of the noise reduction therethrough.

In another example, processor 102 may execute a computationally intensive pixel shader algorithm; said pixel shader algorithm may optimally and/or efficiently execute on processor 102 for a specific set of parameters modifiable through user interface 200. In one or more embodiments, application 114 and/or operating system 128 may be packaged with driver component 170; once the settings discussed above are modified through user interface 200, the definitions/configurations in driver component 170 may be modified automatically. Now when user 150 receives a new notification (e.g., an update) associated with driver component 170, user 150 may not be able to save his/her settings before driver component 170 (and/or the settings) is modified. Even when restoration of settings is possible through reverting back to a state of a file system implemented in operating system 128 by way of a restore point (e.g., implemented in a Windows® operating system), user 150 may not have control of said restoration; further, the restoration may be time-dependent; in other words, the restore points may only be defined for specific points in time separated by a fixed time interval (e.g., 30 minutes).

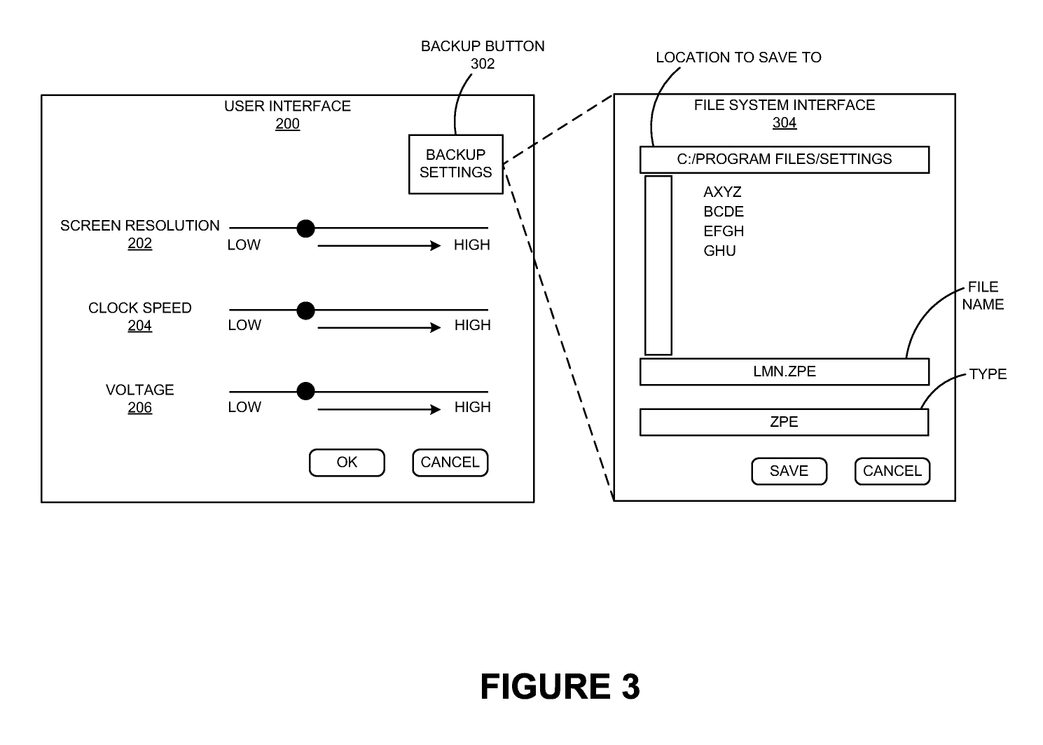

Exemplary embodiments may provide for a means to backup the abovementioned settings before modification thereof due to the automatic updates of driver component 170 (e.g., directly due to updates related to application 114 and/or operating system 128). FIG. 3 shows backup of settings being enabled through user interface 200. Upon user 150 modifying settings through user interface 200 to preferred values thereof, user 150 may be able to backup said preferred settings through clicking a “Backup settings” button (e.g., backup button 302) provided therein. The clicking of backup button 302 may open up a file system interface 304 that enables user 150 to choose the folder in which the preferred settings is to be saved. It is obvious that the folder may refer to a drive associated with a data storage device (e.g., an internal/external hard drive, a Universal Serial Bus (USB) flash drive coupled to data processing device 100).

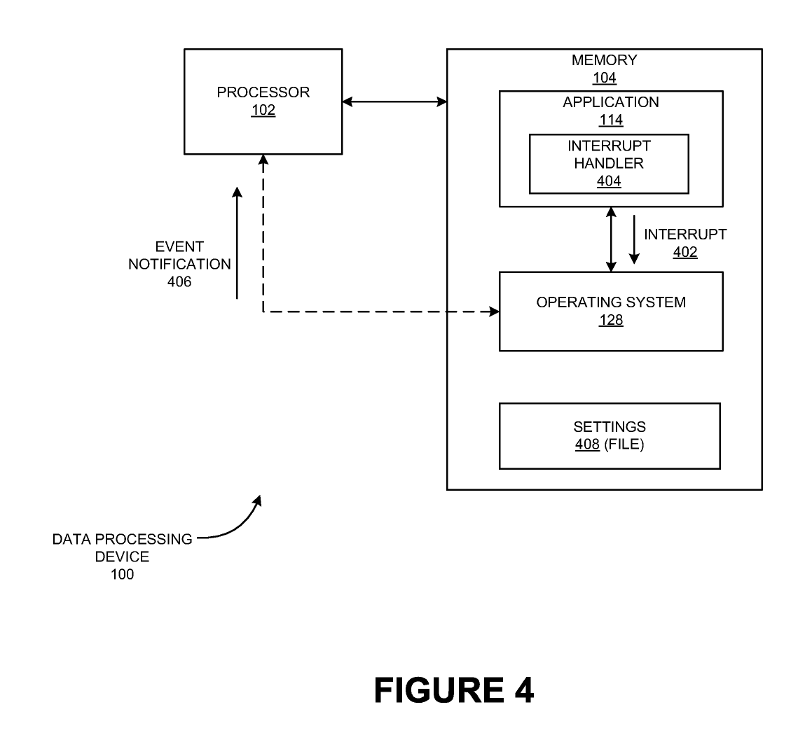

FIG. 4 illustrates data flow between elements of data processing device 100 during the backup of the settings discussed above, according to one or more embodiments. In one or more embodiments, the clicking of backup button 302 by user 150 may generate an interrupt 402 to operating system 128. In one or more embodiments, application 114 and/or operating system 128 may include an interrupt handler 404 to handle said interrupt 402. FIG. 4 shows interrupt handler 404 as being implemented in application 114. In one or more embodiments, following the handling of interrupt 402 through application 114 and/or operating system 128, operating system 128 may then generate an event notification 406 that is detected through processor 102. Thus, in one or more embodiments, processor 102 may be apprised of the need to save the abovementioned settings.

In one or more embodiments, processor 102 may then automatically acquire the settings through triggering execution of a routine associated with driver component 170. In one or more embodiments, processor 102 may then open a file, input the settings therein and save the file to the location desired by user 150. While FIG. 3 shows user 150 choosing the location to store the settings dynamically, it is obvious that user interface 200 may be pre-configured to save the settings in a default location/path modifiable by user 150. FIG. 4 shows settings 408 being stored in memory 104 as a file. It should be noted that settings 408 may be stored as a non-system file to enable easy access by user 150; user 150 may then be able to move settings 408 to external storage such as a USB flash drive.

In another example embodiment, clicking of backup button 302 may automatically trigger the execution of the routine associated with driver component 170 to enable acquisition of the settings. Here, interrupt handler 404 may be implemented in driver component 170. In yet another example embodiment, processor 102 may acquire the settings directly from the appropriate devices (e.g., display unit 106, processor 102, memory 104, power supply 116) through polling the aforementioned devices. All reasonable variations are within the scope of the exemplary embodiments discussed herein.

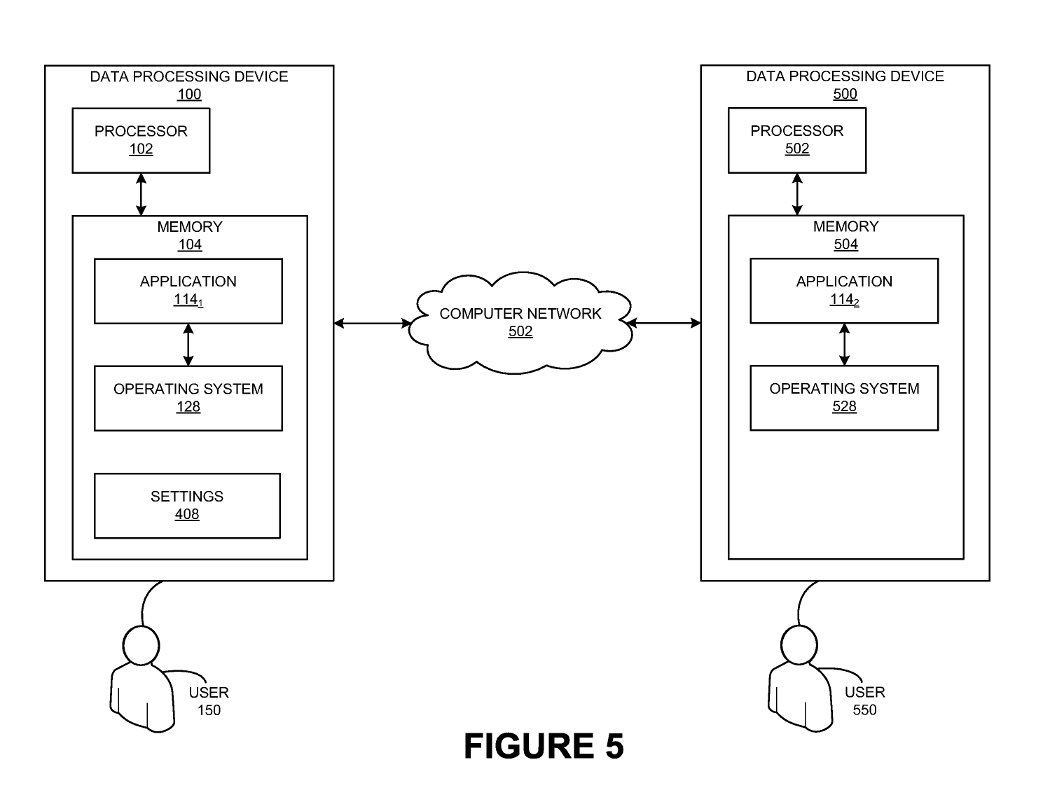

In one or more embodiments, the backing up of settings 408 may enable sharing thereof with another data processing device. For example, settings 408 may be e-mailed to a user of another data processing device. The another data processing device may/may not execute an instance of application 114 thereon. FIG. 5 shows data processing device 100 being coupled to another data processing device 500 also executing an instance of application 114 thereon. Here, data processing device 100 is shown as executing application 114₁ and data processing device 500 is shown as executing application 114₂; processor 502, memory 504 and operating system 528 may be analogous to processor 102, memory 104 and operating system 128 respectively. In one or more embodiments, data processing device 100 may be communicatively coupled to data processing device 500 through a computer network 502 (e.g., Internet, a Wide Area Network (WAN), a Local Area Network (LAN), a Bluetooth® based network, Wi-Fi®, Near Field Communication (NFC) based coupling). It is obvious that user 150 at data processing device 100 may e-mail settings 408 to a user 550 at data processing device 500. Alternately, user 550 may be apprised of settings 408 being received at data processing device 500 through application 114₂.

It should be noted that user 150 at data processing device 100 may be an administrator of computer network 502 including data processing device 100, data processing device 500 and other data processing devices. A backup of settings 408 at data processing device 100 may automatically trigger reception of settings 408 at other devices executing instances of application 114 through computer network 502. Alternately, user 150 may be able to transfer settings 408 to data processing device 500 through a remote desktop access thereof. In another example, data processing device 100 may be a server executing virtual machines (VMs) consolidated on a computing platform thereof. Settings 408 (as a file) may be transferred between VMs.

It is obvious that application 114 at data processing device 100 may leverage an interface (e.g., a web browser (not shown)) to transmit settings 408 to data processing device 500 through e-mail. In another example embodiment, user interface 200 may provide a direct interface for transmitting an e-mail to user 550 at data processing device 500.

In one or more embodiments, backup and/or transmission of settings 408 and portability thereof may enable restoration of optimum/preferred states of processing/computing through data processing device 100. For example, user 150 may backup settings 408 and then opt to continue computing/processing through data processing device 100 based on different settings. Upon browsing through folders of the file system implemented in operating system 128 through user interface 200 and loading settings 408 therethrough, computing/processing through data processing device 100 may be restored to states associated with settings 408. Settings 408 may also be applied through a user interface (not shown) of application 114₂ (and/or operating system 528 executing) executing on data processing device 500 to enable user 550 thereof benefit from the optimal/preferred values of settings 408. Other reasonable modifications and/or simplifications of application of settings 408 on data processing device 100 and/or data processing device 500 are within the scope of the exemplary embodiments discussed herein.

It should be noted that settings 408 may not solely be stored as absolute values of parameters. In an alternate embodiment, settings 408 may be backed up in an incremental manner. For example, user 150 may merely modify a screen resolution and retain all other parameters at current values; settings 408 here may merely include the modifications to screen resolution. Subsequent modifications may be backed up in settings 408 in increments. During restoration, the incremental modifications may be subtracted from the current settings to enable a state restoration to the optimum/preferred state associated with settings 408. Also, it should be noted that settings 408 may be synchronized to one or more e-mail accounts and/or one or more social media network accounts (e.g., Facebook® account) through application 114 to provide for real-time updates to user 150.

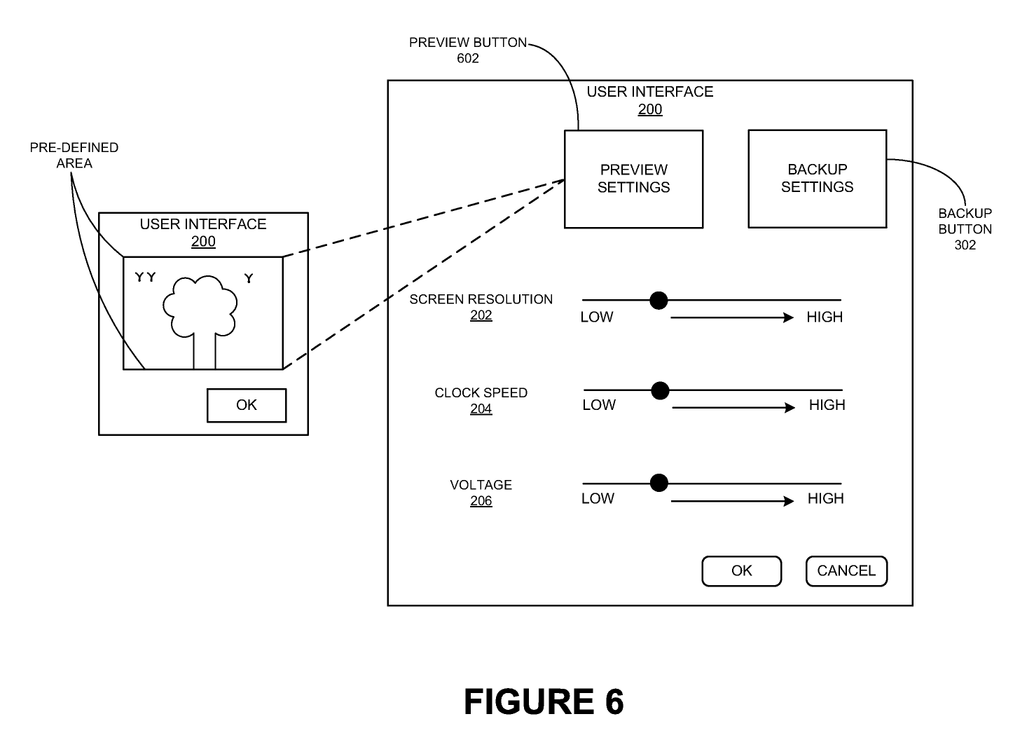

FIG. 6 shows an option to preview settings 408 related to display unit 106 prior to application thereof through user interface 200 associated with application 114 and/or operating system 128 executing on data processing device 100. Here, user interface 200 is shown as including a preview button 602, the clicking of which enables processor 102 place the display data with the modified settings (e.g., through application of settings 408) within a predefined (but modifiable) area on user interface 200. The preview option may enable user 150 make an informed decision with respect to persisting with the modified settings or opting for another set of parameters.

To summarize, exemplary embodiments provide for backing up settings 408 to enable user 150 save time; user 150 may also be able to share settings 408 in the form of one or more files with one or more other users (e.g., user 550). In addition, the preview option may enable user 150 make informed decisions with respect to processing/computing through data processing device 100.

It should be noted that the backing up of settings 408 is not limited to files. Backup of one or more pages associated with application 114 may also be within the scope of the exemplary embodiments. Further, settings 408 may also encompass other parameters such as aspect ratio, orientation, a number of displays (e.g., display unit 106), display layout, color depth, color contrast, texture quality, buffering, frame rate, refresh rate, three-dimensional (3D) performance, edge enhancement, color enhancement, contrast enhancement, power save mode activation and/or optimization and transparency of windows (e.g., windows provided through operating system 128 and/or application 114).

Last but not the least, instructions associated with the backup of settings 408 through user interface 200, driver component 170 and/or application 114 may be embodied on a non-transitory medium (e.g., a Compact Disc (CD), a Digital Video Disc (DVD), a Blu-Ray Disc®, a hard drive) readable through data processing device 100 to be executed therethrough.

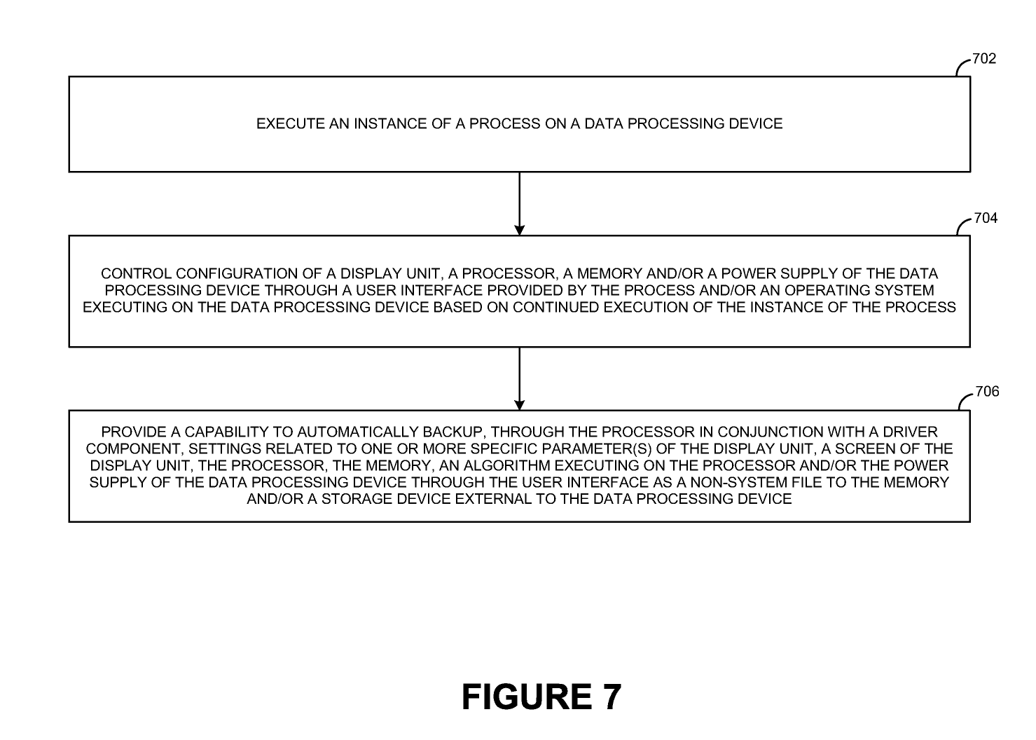

FIG. 7 shows a process flow diagram detailing the operations involved in automatic backup of configuration-related settings (e.g., settings 408) in data processing device 100, according to one or more embodiments. In one or more embodiments, operation 702 may involve executing an instance of a process (e.g., application 114) on data processing device 100. In one or more embodiments, operation 704 may involve controlling configuration display unit 106, processor 102, memory 104 and/or power supply 116 through user interface 200 provided by the process and/or operating system 128 based on continued execution of the instance of the process. In one or more embodiments, operation 706 may then involve providing a capability to automatically backup, through processor 102 in conjunction with driver component 170, settings 408 related to one or more specific parameter(s) of display unit 106, screen 124, processor 102, memory 104, an algorithm executing on processor 102 and/or power supply 116 through user interface 200 as a non-system file to memory 104 and/or a storage device external to data processing device 100.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100, data processing device 500). Accordingly, the specification and drawings are to be regarded in an illustrative rather than a restrictive sense.

What is claimed is:

1. A method comprising:
executing an instance of a process on a data processing device;
controlling configuration of at least one of a display unit, a processor, a memory and a power supply of the data processing device through a user interface provided by at least one of: the process and an operating system executing on the data processing device based on continued execution of the instance of the process; and
providing a capability to automatically backup, through the processor in conjunction with a driver component associated with at least one of the display unit, the processor and the power supply, settings related to at least one specific parameter of at least one of the display unit, a screen of the display unit, the processor, the memory, an algorithm executing on the processor and the power supply of the data processing device through the user interface as a non-system file to at least one of: the memory and a storage device external to the data processing device.

2. The method of claim 1, wherein the automatic backup of the settings further comprises at least one of:
leveraging a file system implemented in the operating system executing on the data processing device through the user interface to backup the settings to the at least one of: the memory and the storage device external to the data processing device;
utilizing the processor to trigger execution of a routine associated with the driver component to acquire the at least one specific parameter; and
polling, through the processor, the at least one of the display unit, the processor, the memory and the power supply of the data processing device to acquire the at least one specific parameter.

3. The method of claim 1, further comprising at least one of:
sharing the backed up settings with another data processing device through a computer network; and
synchronizing the settings to at least one of an e-mail account and a social media network account of a user of the data processing device through the execution of the instance of the process.

4. The method of claim 1, comprising incrementally backing up the settings instead of backing up an absolute value of the at least one specific parameter.

5. The method of claim 1, wherein when a state of at least one of: processing and computing through the data processing device is modified based on a modification of the at least one specific parameter, the method further comprises restoring the state of the at least one of: the processing and the computing through the data processing device to a state associated with the at least one specific parameter prior to the modification thereof upon reading of the backed up settings through the user interface.

6. The method of claim 1, further comprising providing a capability to preview the settings through the user interface.

7. The method of claim 1, comprising executing an instance of an application on the data processing device as the instance of the process,
wherein the backed up settings are capable of including at least one page associated with the application.

8. A non-transitory medium, readable through a data processing device and including instructions embodied therein that are executable through the data processing device, comprising:
instructions to execute an instance of a process on the data processing device;
instructions to control configuration of at least one of a display unit, a processor, a memory and a power supply of the data processing device through a user interface provided by at least one of: the process and an operating system executing on the data processing device based on continued execution of the instance of the process; and
instructions to provide a capability to automatically backup, through the processor in conjunction with a driver component associated with at least one of the display unit, the processor and the power supply, settings related to at least one specific parameter of at least one of the display unit, a screen of the display unit, the processor, the memory, an algorithm executing on the processor and the power supply of the data processing device through the user interface as a non-system file to at least one of: the memory and a storage device external to the data processing device.

9. The non-transitory medium of claim 8, wherein the instructions to automatically backup the settings further comprise at least one of:
instructions to leverage a file system implemented in the operating system executing on the data processing device through the user interface to backup the settings to the at least one of: the memory and the storage device external to the data processing device;
instructions to utilize the processor to trigger execution of a routine associated with the driver component to acquire the at least one specific parameter; and
instructions to poll, through the processor, the at least one of the display unit, the processor, the memory and the power supply of the data processing device to acquire the at least one specific parameter.

10. The non-transitory medium of claim 8, further comprising at least one of:
instructions to share the backed up settings with another data processing device through a computer network; and
instructions to synchronize the settings to at least one of an e-mail account and a social media network account of a user of the data processing device through the execution of the instance of the process.

11. The non-transitory medium of claim 8, comprising instructions to incrementally back up the settings instead of backing up an absolute value of the at least one specific parameter.

12. The non-transitory medium of claim 8, wherein when a state of at least one of:
processing and computing through the data processing device is modified based on a modification of the at least one specific parameter, the non-transitory medium further comprises instructions to restore the state of the at least one of: the processing and the computing through the data processing device to a state associated with the at least one specific parameter prior to the modification thereof upon reading of the backed up settings through the user interface.

13. The non-transitory medium of claim 8, further comprising instructions to provide a capability to preview the settings through the user interface.

14. A data processing device executing an instance of a process comprising:
a memory;
a processor communicatively coupled to the memory;
a display unit; and
a power supply,
wherein at least one of: the process and an operating system executing on the data processing device is configured to provide a user interface to control configuration of at least one of the display unit, the processor, the memory and the power supply therethrough based on continued execution of the instance of the process, and
wherein the user interface is further configured to provide a capability to automatically backup, through the processor in conjunction with a driver component associated with at least one of the display unit, the processor and the power supply, settings related to at least one specific parameter of at least one of the display unit, a screen of the display unit, the processor, the memory, an algorithm executing on the processor and the power supply as a non-system file to at least one of: the memory and a storage device external to the data processing device.

15. The data processing device of claim 14, wherein at least one of:
the instance of the process is configured to leverage a file system implemented in the operating system executing on the data processing device through the user interface to backup the settings to the at least one of: the memory and the storage device external to the data processing device,
the processor is configured to trigger execution of a routine associated with the driver component to acquire the at least one specific parameter, and
the processor is configured to poll the at least one of the display unit, the processor, the memory and the power supply to acquire the at least one specific parameter.

16. The data processing device of claim 14, wherein the settings are configured to be synchronized to at least one of an e-mail account and a social media network account of a user of the data processing device through the execution of the instance of the process.

17. The data processing device of claim 14, wherein the settings are incrementally backed up instead of an absolute value of the at least one specific parameter being backed up in the data processing device.

18. The data processing device of claim 14, wherein when a state of at least one of: processing and computing through the data processing device is modified based on a modification of the at least one specific parameter, the user interface is configured to enable restoration of the state of the at least one of: the processing and the computing through the data processing device to a state associated with the at least one specific parameter prior to the modification thereof based on reading of the backed up settings therethrough.

19. The data processing device of claim 14, wherein the user interface is further configured to provide a capability to preview the settings therethrough.

20. The data processing device of claim 14,
wherein the instance of the process is an instance of an application executing on the data processing device, and
wherein the backed up settings are capable of including at least one page associated with the application.
